(19) United States
(12) Patent Application Publication
(10) Pub. No.: US 2003/0205546 A1
(43) Pub. Date: Nov. 6, 2003

(54) Display with appurtenance attachment system

(76) Inventors: Mark Fritsche, Eagan, MN (US); Dan Berg, Minneapolis, MN (US); Jason Johnson, Minneapolis, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/953,098

(22) Filed: Sep. 13, 2001

(51) Int. Cl. E04H 12/00; E06B 3/54

(52) U.S. Cl. 211/189; 52/220.7; 52/648.1; 52/474

(57) ABSTRACT

The frame attachment system of the present invention is a unitary-bodied frame attachment member being selectively and removably attachable to a display frame member for attaching shelving brackets, and attachments of the like. The present invention essentially includes three portions: a bracing portion, a grasping portion, and a slot portion. The grasping portion is substantially u-shaped for attachment around a display frame member with the bracing portion being in perpendicular opposition to the grasping portion. The slot portion is proximate the bracing portion and includes a plurality of slots capable of receiving shelving brackets such that the insertion of a shelving bracket results in the bracket flushly resting against the frame member and thus limiting movement of the frame attachment member. Fastening means, such as a magnet, can be fixed to the inner surface of the grasping portion to better facilitate attachment of the grasping portion to the vertical frame member prior to receipt of the shelving bracket.

### FIELD OF THE INVENTION

The present invention relates to displays, and in particular, to a removably mountable attachment system for receiving hooked appurtenance brackets.

### BACKGROUND OF THE INVENTION

In the construction of exhibit and display stands, it is a conventional practice to utilize various truss and frame structures to assist in erecting and configuring the walls that create the backdrop for a particular vendor's defined booth space. Typically, frame and truss structures are designed so that they are readily disassemblable and collapsible for transportation to and from trade shows or other exhibitions.

Since these frame structures are collapsible and portable, nearly each component associated with these display stands must be separately detachable, including appurtenance such as shelving, and the brackets which are used to attach the appurtenances to various display frame segments. Conventional practice is to machine the surface of the frame structures with slots designed to removably receive the brackets. Consequently, in an attempt to provide numerous options in the mounting locations and configurations for appurtenances, the entire surface of each frame segment is generally slotted to accommodate hooked brackets.

This desire to provide multiple configuration options comes with obvious costs. First, only a limited number of these frame slots will actually be used to attach hooked brackets. However, since the manufacturer is incapable of knowing in advance the anticipated uses of each end user, each frame segment must be slotted so that the entire segment is hook-bracket-ready. This sort of inefficiency results in greatly increased manufacturing costs. Second, the machining of excessive slots is simply aesthetically unappealing. This can be a significant liability in the world of trade show displays where attractive eye-catching displays ultimately define success.

Consequently, there is a need for a frame attachment system which can be selectively coupled only to those segments of the framing structure where appurtenances are needed. In addition, such an attachment must be designed to reduce manufacturing costs and to increase the aesthetic appeal of the display stand.

### SUMMARY OF THE INVENTION

A display has a plurality of vertical columns, with vertical frame members, a slotted C-shaped circumferential frame attachment member, and a hooked appurtenance bracket to engage with the slots of the attachment. The frame attachment member of the present invention is removably attachable to a vertical frame member for attaching shelving brackets, and brackets for other appurtenances. The frame attachment member essentially includes three portions, a bracing portion, a grasping portion, and a slot portion. The grasping portion is substantially u-shaped for attachment around a vertical frame member with the bracing portion being in perpendicular opposition to the grasping portion. The slot portion is proximate the bracing portion and includes a plurality of slots capable of receiving hooked brackets such that the insertion of a hooked bracket results in the bracket flushly resting against the vertical frame member and capturing the frame attachment member on the vertical frame member. Fastening means, such as a magnet, can be fixed to one of the inner surfaces of the grasping portion to better facilitate attachment of the grasping portion to the vertical frame member prior to receipt of the hooked bracket.

A significant feature and advantage of the present invention is that the frame attachment member is selectively and removably attachable to any vertical frame member. Consequently, multiple configuration options are made available to the end user. A frame attachment member can be utilized in only those areas where a specific configuration is desired. Furthermore, a specific vertical frame member can be targeted, with the present invention being attachable such that hooked brackets can be attached at varying angles on the targeted vertical frame member.

Another significant feature and advantage of the present invention is that it allows for more visually appealing display frame structures. The use of the selectively removable frame attachment members of the present invention eliminates the conventional need for machining unattractive slots into more vertical frame members than is needed.

A further feature and advantage of the present invention is that manufacturing costs are significantly reduced since it is no longer necessary to machine bracket slots into each vertical frame member.

Yet another feature and advantage of the present invention is that it can be constructed of thin sheet metal to reduce manufacturing costs. In addition, thinner sheet metal results in a lighter component to better facilitate portability.

A still further feature and advantage of the present invention is that it is capable of receiving commercially available hooked bracket accessories, such as those readily used in shelving.

Another feature and advantage of the present invention is that attachment to the display frame structure is done without tightly clasping or grasping onto the frame. As a result, scratching and other damage to the face of the outer surface of the vertical frame member is minimized.

The following U.S. patent applications are being filed by the same applicant on the same day as this application and are hereby incorporated by reference: U.S. patent application Ser. No. ______, entitled “SCREEN MOUNTING APPARATUS”; U.S. patent application Ser. No. ______, entitled “BOX FRAME ASSEMBLY”; U.S. patent application Ser. No. ______, entitled “MODULAR MULTI-CONFIGURABLE DISPLAY SYSTEM”.

### BRIEF DESCRIPTION OF THE DRAWINGS

FIG. 1 is a perspective view of a box frame assembly with frame attachment members and appurtenance brackets attached thereto in accordance with the invention.

FIG. 2 is an exploded view of a vertical support member, frame attachment member, and appurtenance brackets in accordance with the invention.

FIG. 3 is a display incorporating the invention herein.

FIG. 4 is a schematic plan view of the display of FIG. 3.

FIG. 5 is a elevational view of a vertical support member with a frame attachment member and an appurtenance bracket attached thereto.

FIG. 6 is a cross-sectional view taken at line 66 of FIG. 5.

FIG. 7 illustrates features of an alternative embodiment of the invention.

### DETAILED DESCRIPTION OF THE PREFERRED EMBODIMENTS

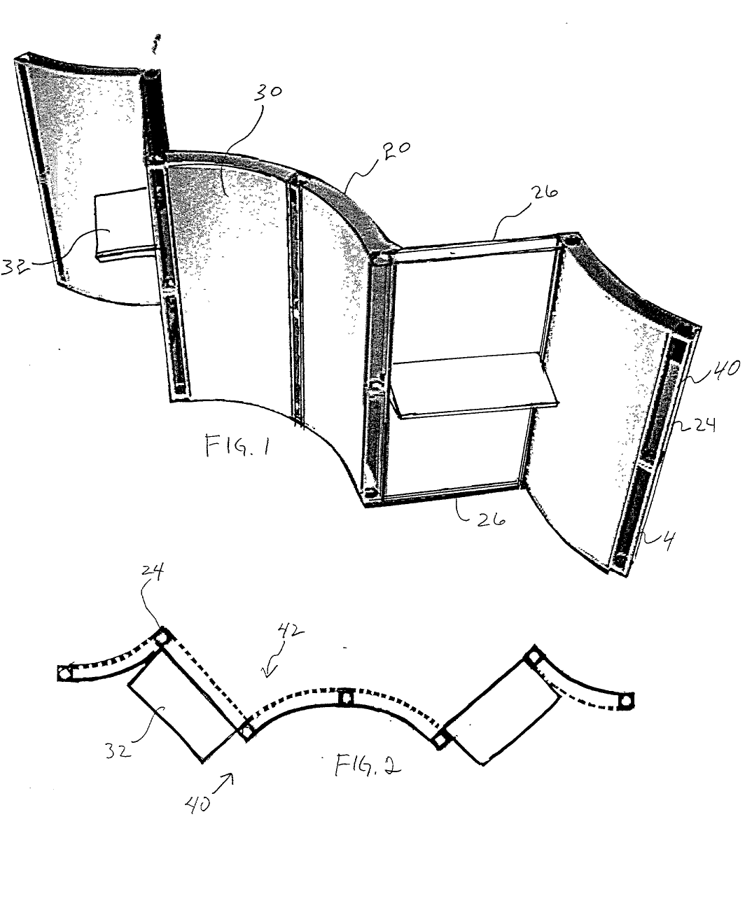

Referring to FIG. 1, a portable disassemblable display structure 20 is shown in which intended for use at trade shows and specifically suitable for use as a back wall at such trade show exhibits. The display structure comprises a plurality of vertical columns 24, a plurality of horizontal spanning members 26, screens 30, and appurtenances configured as shelves 32. The display has a unique configuration as illustrated in FIG. 2 with the screens illustrated in heavy dark lines intermediate the vertical columns capable of being put on either the front 40 or the back 42 of the display 20. Moreover, the appurtenances configured as shelves 32, 33 have one shelf 32 extending from the front side of the display 20 in a forward direction, and another shelf 33 extending from the back side of the display also in a forwardly direction.

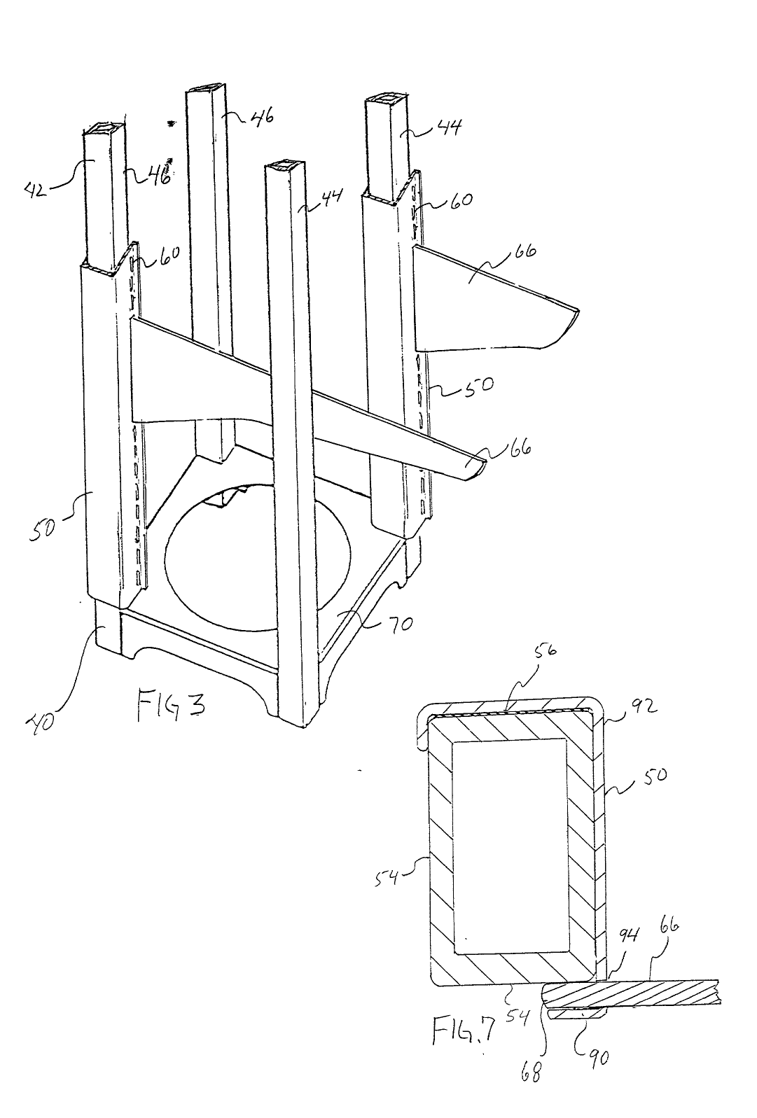

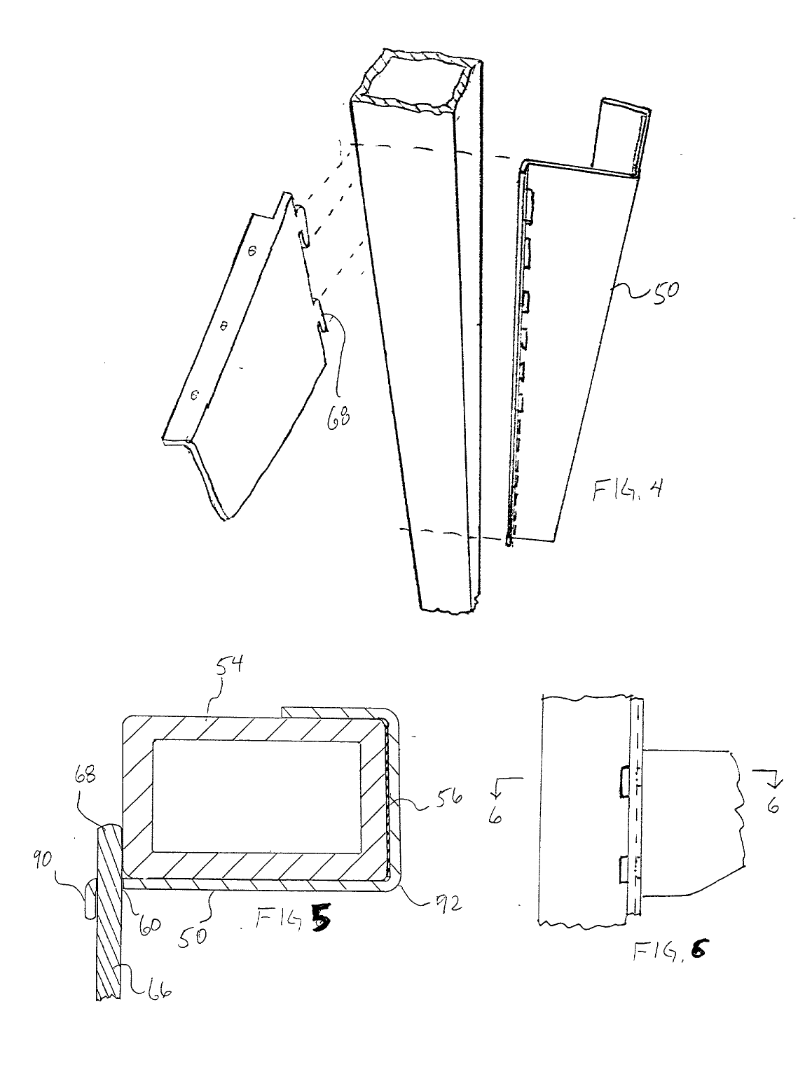

Referring to FIGS. 3 and 4, effectuating the flexibility of attaching the appurtenance from the front side or the back side of the display 20 is the vertical column box unit 40 which has a plurality of vertical support members 42 which include a pair of front side members 44 and a pair of back side members 46. C-shaped circumferential frame attachment members 50 extend around four sides 54 of the vertical support member and are in an engagement relationship on three of the sides. A strip of magnetic material 56 may be adhesively attached to the frame attachment member to secure the frame attachment member to the vertical frame member. The frame attachment member has a plurality of vertically aligned slots 60 configured for receiving a hook bracket 66. The hook brackets 66 may be variously designed for support or securing appurtenance such as shelves, bars, tables, and the like. Insertion of the hooks 68 of the hooked appurtenance bracket 66 into the slots 60 of the frame attachment member 50 when the frame attachment member 50 is wrapped around and engaged with the vertical column effectively secure and captures the vertical column within the combination of the frame attachment member 50 and hooked appurtenance bracket 66. As illustrated in FIG. 3, the frame attachment member 50 may rest on a base 70 of the vertical columns or other means may be provided for vertically stabilizing the frame attachment member 50 to the vertical column. Such means includes the magnet strip 56 as illustrated in FIG. 7.

The frame attachment member 50 comprises a bracing portion 90, a grasping portion 92, and a slot portion 94. The grasping portion 90 has three linear segments generally defining a J-shape. The bracing portion 90 provides stability to the hooked appurtenance bracket 66 and may extend in the direction as shown in FIG. 7, or in the opposite direction as shown in FIG. 6. The specification configuration as shown in FIG. 6 provides better protection from marring and scratching of the vertical frame member 54 in that the hooked appurtenance bracket 66 may be inserted at an angle into the slot 60 of the frame attachment member 50 at a slight angle such that there is no direct sliding or scraping contact between the hook portion 68 and the vertical frame member 54. That is to say, the hooked appurtenance bracket 66 may be rotated as shown in FIG. 6 in a slightly counter-clockwise direction prior to insertion in the slot 60.

Although the strip of magnetic material 56 is illustrated on the interior surface of the J-shaped grasping portion opposite the slot, the magnetic material could be put on another inside surface location of the frame attachment member 50.

The attachment member 50 is preferably made of sheet metal with the slots punched therein and the sheet metal appropriately formed in the shape formed as illustrated. The hooked appurtenance brackets 66 may be conventional brackets as currently available for shelves and for mounting other appurtenances.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed is:

1. A frame attachment system for removably securing a frame attachment member to a vertical display frame member for receiving hooked brackets, the frame attachment system comprising:
a unitary-bodied selectively removable frame attachment member having:
a grasping portion being generally u-shaped for fitting substantially around the display frame member;
a bracing portion in perpendicular opposition to the grasping portion for limiting movement of the received hooked bracket; and
a slot portion having a plurality of vertically spaced aperture slots for receiving the hooked brackets such that an end of the received hooked bracket continues some distance past the slot for limiting movement of the frame attachment from the display frame member.

2. The frame attachment system of claim 1, further comprising a thin magnet fixedly attached to an inner surface of the grasping portion for securement of the grasping portion to the display frame member.

3. The frame attachment system of claim 1, wherein the frame attachment member is a length generally equal to the length of one display frame member for providing vertical stability.

4. The frame attachment system of claim 1, further comprising a base attached to the display frame members for vertically stabilizing the frame attachment member.

5. The frame attachment system of claim 1, wherein the hooked bracket is a shelving bracket.

6. A frame attachment system for removably securing a frame attachment member to a vertical display frame member for receiving hooked brackets, the frame attachment system comprising:
a hooked bracket;
a vertical display frame member; and
a unitary-bodied selectively removable frame attachment member having:
a grasping portion being generally u-shaped for fitting substantially around the display frame member;
a bracing portion in perpendicular opposition to the grasping portion for limiting movement of the received hooked bracket; and
a slot portion having a plurality of vertically spaced aperture slots for receiving the hooked brackets such that an end of the received hooked bracket continues some distance past the slot for limiting movement of the frame attachment from the display frame member.

7. A method of installing a frame attachment system comprising the steps of:
aligning a slotted u-shaped frame attachment member such that the u-shaped opening of the apparatus is in proximate alignment with a vertical display frame member;
removably securing the frame attachment member to the vertical display frame member such that the frame attachment member substantially wraps around the vertical display frame member; and
inserting a hooked bracket into the frame attachment member slots such that the inserted end of the hooked bracket stabilizes the securement of the frame attachment member against the vertical display frame member.
